(19) United States
(12) Patent Application Publication
(10) Pub. No.: US 2009/0050179 A1
(43) Pub. Date: Feb. 26, 2009

(54) Cleaner composition consisting of alkalic agent, sodium polyacrylate and sterilizer and cleaning method using the same

(75) Inventors: Seog Jin Kang, Cheonan-si (KR); Tai Young Hur, Cheonan-si (KR); Guk Hyun Suh, Cheonan-si (KR); Hyeon Shup Kim, Suwon-si (KR); Kwang Su Baek, Suwon-si (KR); Youn Gyo Lee, Icheon-si (KR); Hyun Soo Kim, Seoul (KR); In Thaek Rim, Seoul (KR); Yun Seok Cho, Seoul (KR)

Correspondence Address: BUCHANAN, INGERSOLL & ROONEY PC, POST OFFICE BOX 1404, ALEXANDRIA, VA, 22313-1404, US

(73) Assignees: Republic of Korea (Management: Rural Development Administration), Suwon-si (KR); NUVO B&T CORPORATION, Gyeonggi-do (KR); UCAS CO., LTD., Gyeonggi-do (KR)

(21) Appl. No.: 12/215,409

(22) Filed: Jun. 27, 2008

(30) Foreign Application Priority Data
Aug. 20, 2007 (KR) 10-2007-0083396

(51) Int. Cl. B08B 7/04; C11D 3/20

(52) U.S. Cl. 134/18; 510/218

(57) ABSTRACT

The present invention relates to a cleaner composition comprising an alkalic agent, sodium polyacrylate as ion exchanger, a sterilizer and water, and a cleaning method using the same. More particularly, the present invention relates to a cleaner composition comprising 5 to 15 weight % of an alkalic agent, 5 to 20 weight % of sodium polyacrylate having a molecular weight 4,000 to 10,000 as ion exchanger, 0.5 to 30 weight % of a sterilizer, and water as remainder, and a cleaning method using the same. The cleaner composition of the present invention provides the effect of removing fats, proteins, minerals, etc. comparable to or better than that of the conventional cleaner, and can reduce cleaning time and cost because the cleaning process is simplified. Hence, it can be utilized to clean milking machines or other appliances.

### CROSS-REFERENCE TO RELATED APPLICATION

This application claims priority under 35 U.S.C. §119 to Korean Patent Application No. 10-2007-0083396, filed on Aug. 20, 2007, in the Korean Intellectual Property Office, the entire contents of which are incorporated herein by reference.

### BACKGROUND

1. Technical Field

The present invention relates to a cleaner composition comprising an alkalic agent, sodium polyacrylate as ion exchanger, a sterilizer and water, and a cleaning method using the same. More particularly, the present invention relates to a cleaner composition comprising 5 to 15 weight % of an alkalic agent, 5 to 20 weight % of sodium polyacrylate having a molecular weight 4,000 to 10,000 as ion exchanger, 0.5 to 30 weight % of a sterilizer, and water as remainder, and a cleaning method using the same.

2. Description of the Related Art

The main components of milk are water, fats, proteins, lactose, minerals, etc. In the milking process, these components may act as contaminants. The major contamination sources of milking equipments are: milk film which is formed as raw milk becomes dry and attaches to the equipments; milk scale which is formed as proteins and minerals are accumulated over a long period of time because the milk film is not removed sufficiently, and becomes a microbiological contamination source; milk stone which is a sponge-like accumulation denatured proteins; chloroprotein which is formed when the protein impurities remaining without being removed contact with a chlorine-based sterilizer or when fresh milk contacts with the surface a milking machine that has been sterilized with a chlorine-based sterilizer; and the like.

In order to prevent such contamination and destroy various harmful microorganisms, an acidic cleaner and an alkaline cleaner have to be used following milking, depending on the particular contamination sources. And, for the purpose of sterilization, a product comprising an alkaline cleaner and a sterilizer such as sodium hypochlorite has to be used. Such conventional products contain inorganic acids like phosphoric acid, nitric acid, sulfuric acid, etc. as acidic cleaner and strong alkalis like sodium hydroxide, potassium hydroxide, etc. as alkaline cleaner. Thus, they require special cares and lay large burden on the environment. Further, because the cleaners cannot be used as mixed together, a two-step cleaning is inevitable. If an acidic cleaner is mixed with an alkaline cleaner, the cleaning ability of both of the cleaners may be lost and a chemical reaction may occur. Thus, the cleaning should be carried out in two steps, which is disadvantageous in terms of cleaning time, consumption of water for cleaning and rinsing, etc. Besides, products containing a surfactant for a strong cleaning ability have the problem in rinsing, because foams are generated when they are injected under high pressure.

Accordingly, development of a one-step cleaner that can conveniently remove contaminants including milk film, milk scale, milk stone, chloroprotein, etc., is safe and unharmful, can save time and cost, and does not contain a surfactant is required.

The inventors of the present invention have worked to develop such a one-step cleaner. As a result, they developed a novel one-step cleaner composition comprising 5 to 15 weight % of an alkalic agent, 5 to 20 weight % of sodium polyacrylate having a molecular weight 4,000 to 10,000 as ion exchanger, 0.5 to 30 weight % of a sterilizer, and water as remainder.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with the prior art, and an object of the present invention is to provide a novel one-step cleaner composition and a use thereof.

To attain the object, the present invention provides a novel one-step cleaner composition comprising 5 to 15 weight % of an alkalic agent, 5 to 20 weight % of sodium polyacrylate having a molecular weight 4,000 to 10,000 as ion exchanger, 0.5 to 30 weight % of a sterilizer, and water as remainder.

### DETAILED DESCRIPTION OF THE INVENTION

Hereinafter, reference will be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined in the appended claims.

The cleaner composition of the present invention is characterized by comprising 5 to 15 weight % of an alkalic agent, 5 to 20 weight % of sodium polyacrylate having a molecular weight 4,000 to 10,000 as ion exchanger, 0.5 to 30 weight % of a sterilizer, and water as remainder.

In the present invention, the alkalic agent serves to remove milkfat and milk protein contaminants. A mixture of sodium carbonate and at least one compound selected from potassium carbonate, potassium bicarbonate, sodium phosphate, sodium metaphosphate, sodium pyrophosphate, potassium pyrophosphate, sodium silicate and sodium metasilicate can be used, in an amount of 5 to 15 weight % based on the total weight of the composition. When the content of the alkalic agent is below 5 weight %, cleaning performance is not good. And, when and the content exceeds 15 weight %, it is difficult to maintain the cleaner in homogeneous phase, particularly in winter season, and crystallization may occur. And, it is preferred to use sodium carbonate along with at least one compound selected from potassium carbonate, potassium bicarbonate, sodium phosphate, sodium metaphosphate, sodium pyrophosphate, potassium pyrophosphate, sodium silicate and sodium metasilicate, because cleaning performance may be insufficient when sodium carbonate is used alone.

Sodium polyacrylate is a kind of food additive used to increase adhesion property and viscosity of food, enhance emulsion stability, and improve tactile sensation and other physical properties of food. In the present invention, the sodium polyacrylate is used as ion exchanger to remove ions. Preferably, sodium polyacrylate having a molecular weight 4,000 to 10,000 is used in an amount of 5 to 20 weight % based on the total weight of the composition. When the molecular weight of sodium polyacrylate is smaller than 4,000, removal of concentrated metal ions is easy, but the contaminants may adhered to the surface again because they are not dispersed sufficiently. And, when the molecular weight exceeds 10,000, the sodium polyacrylate serves only as dispersant because of poor chelating ability. And, when the consent of the sodium polyacrylate is below 5% based on the total weight of the composition, contaminants may not be removed completely. And, when it exceeds 20%, it is difficult to maintain the cleaner in homogeneous phase.

In the present invention, the sterilizer serves to kill the microorganisms inside the milking apparatus and reduce the number of microorganisms in raw milk. For the sterilizer, at least one compound selected from sodium hypochlorite, sodium benzoate, sodium paraoxybenzoate, ethanol, chlorobutanol, hexamethylenetetramine, glutaraldehyde, chloroacetamide, quaternium-15, imidazolidinyl urea, potassium sorbate, p-hydroxybenzoic acid, benzyl ether of p-hydroxybenzoic acid, chloroxylenol, chlorothymol, 2,4-dichloro-3,5-xylenol, o-phenylphenol, 2-benzyl-4-chlorophenol, 2,4,4-trichloro-2-hydroxydiphenyl ether, 3,4,4-trichlorocarbanilide, 4,4-dimethyl-1,3-oxazolidine, polyhexamethylene biguanide hydrochloride, alkyltrimethylammonium bromide, benzalkonium chloride and benzethonium chloride may be used, preferably in an amount of 0.5 to 30 weight % based on the total weight of the composition. When the content of the sterilizer is below 0.5 weight % based on the total weight of the composition, sterilizing power may be insufficient. And, when it exceeds 30 weight %, it is difficult to maintain the cleaner in homogeneous phase.

For the convenience of maintaining properties and preparation, the cleaner composition of the present invention is preferably prepared by dissolving an alkalic agent in water, and then adding sodium polyacrylate as ion exchanger and a sterilizer, in that order, to obtain a homogeneous phase.

The cleaner composition of the present invention may be applied for cleaning of anything requiring the removal of proteins, fats and minerals. Preferably, it may be used to clean a milking machine. In addition, it can be used to clean a plastic bucket or to remove scales from the bathroom floor or tiles needed to be cleaned or sterilized.

The present invention further provides a method for cleaning a milking machine using the cleaner of the present invention.

Because cleanness of a milking machine is linked directly with the quality of raw milk, diary farmers clean and sterilize it immediately after milking. In general, the cleaning and sterilization consist of the following procedures. First, the outside of a milking machine is washed with flowing water, and cold or tepid water is sucked in through a teat cup after operating the milking machine (pre-cleaning). Then, after sucking in water of 60 to 70° C. in which caustic soda is dissolved at a concentration of 0.2 to 0.3% through the teat cup (first cleaning), washing is carried out as above using cold or tepid water (first rinsing). Then, after sucking in water in which phosphoric acid or nitric acid is diluted to 0.2 to 0.3% through the teat cup (second cleaning), washing is carried out as above using cold or tepid water (second rinsing).

As such, the conventional cleaning method requires two steps, each using an acidic cleaner and an alkaline cleaner, respectively. In contrast, the cleaning method using the cleaner of the present invention enables removal of milkfats, milk proteins, minerals, and the like through a one-step washing. Therefore, it provides advantages in cleaning time, consumption of water for cleaning and rinsing, prevention of environmental pollution, and the like.

This advantageous effect is attained because an ion exchanger that removes mineral ion contaminants through ion exchange is used instead of an acidic cleaner containing sulfuric acid, phosphoric acid, nitric acid, etc. for the removal of milk scales and milk stones, and it is used in combination with an alkaline cleaner for the removal of milkfats and milk proteins.

The detailed cleaning method may be the same with or similar to the cleaning method using a conventional cleaner. Although not limited thereto, the cleaning method may comprise: a pre-cleaning step of washing the milking machine to be cleaned with water, a cleaning step of cleaning milking machine using the cleaner of the present invention, and a rinsing step of removing the cleaner.

As described in the following Examples section, a cleaner composition according to the present invention, a cleaner composition containing a higher concentration of an alkalic agent, a cleaner composition not containing a sterilizer, a cleaner composition containing sodium polyacrylate with a larger molecular weight, an acidic cleaner composition, and an alkaline cleaner composition were prepared.

And, as described in the following Testing Examples section, cleaning performance for proteins, fats and minerals, number of microorganisms, maintenance of homogeneous phase, and consumption of water for cleaning were compared for the cleaner compositions. As a result, it was confirmed that the cleaner composition of the present invention provides superior cleaning power, reduces number of microorganisms, maintains properties stably, and consumes less water for cleaning.

The cleaner composition of the present invention, which comprises an alkalic agent, sodium polyacrylate, a sterilizer and water, provides the effect of removing fats, proteins, minerals, etc. comparable to or better than that of the conventional cleaner, and can reduce cleaning time and cost because the cleaning process is simplified. Hence, it can be utilized to clean milking machines or other appliances.

### EXAMPLES

The following examples illustrate the invention and are not intended to limit the same.

### Examples 1 to 3

### Preparation of Cleaner Compositions of the Present Invention (Water-Based Cleaner)

As listed in Table 1 below (unit: weight %), cleaner compositions of the present invention were prepared as follows. Sodium carbonate and sodium phosphate were completely dissolved in purified water. Then, sodium polyacrylate having a molecular weight of 6,000 was added and completely dissolved. Then, sodium hypochlorite was added and completely dissolved to obtain the cleaner compositions of the present invention.

### Comparative Examples 1 to 6

### Preparation of Cleaner Compositions

Cleaner compositions were prepared as listed in Table 1.

TABLE 1

| | | | | Comp. | Comp. | Comp. | Comp. | Comp. | Comp. |
|---|---|---|---|---|---|---|---|---|---|
| | Ex. 1 | Ex. 2 | Ex. 3 | Ex. 1 | Ex. 2 | Ex. 3 | Ex. 4 | Ex. 5 | Ex. 6 |
| Purified water | 59.0 | 59.0 | 53.0 | 65.0 | 35.0 | 78 | 58 | 85 | 72 |
| Sodium carbonate | 5 | 10 | 5 | 5 | 15 | 5 | 5 | — | — |
| Sodium phosphate | 1 | 1 | 2 | — | 15 | 2 | 2 | — | — |
| Sodium hydroxide | — | — | — | — | — | — | — | — | 8 |
| Sulfuric acid | — | — | — | — | — | — | — | 10 | — |
| Phosphoric acid | — | — | — | — | — | — | — | 5 | — |
| Sodium hypochlorite | 25 | 25 | 30 | 20 | 25 | — | 25 | — | 20 |
| Sodium polyacrylate | 10 | 5 | 10 | 10 | 10 | 15 | — | — | — |
| (M.W. = 6,000) | | | | | | | | | |
| Sodium polyacrylate | — | — | — | — | — | — | 10 | — | — |
| (M.W. = 12,000) | | | | | | | | | |

### Test Examples

### Test Example 1

### Comparison of Cleaning Power

1-1. Cleaning Using Cleaner Compositions

A milking apparatus was cleaned using each of the cleaners prepared in Examples 1 to 3 and Comparative Examples 1 to 6. The final cleaning water was collected following the last cleaning step in a 50 mL sterilized container and used as sample for analysis.

1-2. Removal of Proteins

For the samples of the cleaner compositions obtained in Test Example 1-1, protein removal efficiency (%) was calculated as the ratio of the protein content of the sample to the protein content of milk (3.2 g per 100 mL).

Protein content of the sample was determined by the Bradford protein assay. Sample was diluted at 10 gradual concentrations. After adding Bio-Rad reagent (Sigma, USA) and keeping at room temperature for 5 minutes, absorbance measured at 595 nm using a spectrophotometer (Tecan, USA) was compared with the standard curve.

As shown in Table 2, the acidic cleaner composition of Comparative Example 5 exhibited low protein removal efficiency. But, all other cleaner compositions except for Comparative Example 5 showed good and comparable protein removal efficiency.

1-3. Removal of Fats

For the samples of the cleaner compositions obtained in Test Example 1-1, fat removal efficiency (%) was calculated as the ratio of the fat content of the sample to the fat content of milk (3.9 g per 100 mL).

Fat content of sample was determined by TLC (thin layer chromatography). A TLC plate was prepared and activated by heating at 100-200° C. for 30-60 minutes. A 70:30:2 mixture solution of petroleum ether:diethyl ether:acetic acid was put in a TLC chamber and activation was carried out for 12 hours. After applying spots of reference material and sample on the TLC plate, the TLC plate was put in the saturated TLC chamber. When development was completed, 50% HSO, a coloring agent, was sprayed on the TLC, and coloring was carried out by heating at 150-180° C. Then, the TLC plate was dried and fat content was determined from the distance traveled by the mobile phase.

As shown in Table 2, the acidic cleaner composition of Comparative Example 5 exhibited low fat removal efficiency. But, all other cleaner compositions except for Comparative Example 5 showed good and comparable fat removal efficiency.

1-4. Removal of Minerals

For the samples of the cleaner compositions obtained in Test Example 1-1, mineral removal efficiency (%) was calculated as the ratio of calcium, phosphorus, potassium and magnesium contents of the sample to those of milk (Ca: 1050 mg/L, P: 860 mg/L, K: 151 mg/L, Mg: 124 mg/L).

Ca and K contents were analyzed as follows. Cleaning water was filtered through 0.2 μm filter paper. Reference materials (K: 0.1, 0.5, 1 ppm, Ca: 0.5, 1, 3, 5 ppm) were prepared from AccTrace Reference AA Standard 1,000 ppm to prepare standard curves. After diluting the sample based on the standard curve, content of each element was quantitatively analyzed by MS (atomic absorption spectroscopy). P and Mg contents were analyzed as follows. Cleaning water was filtered through 0.2 μm filter paper. Reference materials (P: 50, 200, 300 ppb, Mg: 100, 200, 300 ppb) were prepared from AccTrace Reference ICP-MS Standard 10 ppm to prepare standard curves. After diluting the sample based on the standard curve, content of each element was quantitatively analyzed by ICP-MS (inductively coupled plasma mass spectrometry).

As shown in Table 2, the cleaner composition containing sodium polyacrylate with a larger molecular weight (Comparative Example 4) and the strongly alkaline cleaner composition (Comparative Example 6) exhibited low mineral removal efficiency. But, all other cleaner compositions showed good and comparable mineral removal efficiency.

1-5. Removal of Microorganisms

For the samples of the cleaner compositions obtained in Test Example 1-1, total bacterial count was determined after diluting samples at 10 gradual concentrations and culturing in Mueller-Hinton agar (Difco, USA) for 24 hours.

As shown in Table 2, the cleaner compositions not containing the sterilizer sodium hypochlorite (Comparative Examples 3 and 5) exhibited increased total bacterial count. But, all other cleaner compositions showed good bacterial removal efficiency.

TABLE 2

| | | | | | | | Total | | |
|---|---|---|---|---|---|---|---|---|---|
| | | | | | | | bacterial | | |
| | | | | | | | count in | | Daily |
| | | | | | | | cleaning | | consumption |
| | Contaminant removal efficiency (%) | | | | | | water | Homogeneous | of cleaning |
| | Protein | Rat | Ca | P | K | Mg | (CFU/mL) | phase | water (L) |
| Ex. 1 | 97.8 | 97.9 | 98.73 | 99.99 | 99.21 | 96.87 | 20 | Yes | 300 |
| Ex. 2 | 98.1 | 98.0 | 98.53 | 99.81 | 99.17 | 9667 | 21 | Yes | 300 |
| Ex. 3 | 98.1 | 98.36 | 98.66 | 99.94 | 99.35 | 96.85 | 18 | Yes | 300 |
| Comp. | 90.1 | 96.1 | 98.71 | 99.98 | 99.17 | 96.85 | 19 | Yes | 300 |
| Ex. 1 | | | | | | | | | |
| Comp. | 98.9 | 99.1 | 98.77 | 99.99 | 99.19 | 96.85 | 19 | No | 300 |
| Ex. 2 | | | | | | | | | |
| Comp. | 98.1 | 98.3 | 98.72 | 99.99 | 99.24 | 96.69 | 40 | Yes | 300 |
| Ex. 3 | | | | | | | | | |
| Comp. | 98.1 | 98.5 | 85.43 | 84.72 | 86.75 | 83.46 | 20 | Yes | 300 |
| Ex. 4 | | | | | | | | | |
| Comp. | 87.0 | 88.4 | 98.41 | 99.98 | 99.07 | 96.43 | 38 | Yes | 200 |
| Ex. 5 | | | | | | | | | |
| Comp. | 97.6 | 97.8 | 85.1 | 85.4 | 87.1 | 83.44 | 19 | Yes | 200 |
| Ex. 5 | | | | | | | | | |

In case of Comparative Example 2, a homogeneous phase was not maintained as the minerals were not completely dissolved but sedimented at the bottom, resulting in two layers. In case of Comparative Examples 5 and 6, which are an acidic cleaner and an alkaline cleaner, respectively, the daily consumption of cleaning water becomes 400 L (200 L+200 L) because cleaning has to be performed using both the alkaline cleaner and the acidic cleaner.

To conclude, the cleaner composition according to the present invention removes proteins, fats and minerals well, and inhibit the proliferation of microorganisms well. Further, because the number of cleaning can be reduced from two (when acidic and alkaline cleaners are used separately) to one, consumption of the cleaning water and cleaning time can be reduced.

### Test Example 2

### Comparison of Cleaning Performance

2-1. Cleaner Compositions and Selection of Farmhouses

Three dairy cattle breeding farmhouses which are using conventional cleaners were selected. Test samples were taken at the dairy cattle breeding facility of the Livestock Resources Development Department of the NIAS (National Institute of Animal Science). After cleaning using each cleaner to remove the milk components remaining in the milking apparatus and the raw milk tank following milking, the final cleaning water was collected in a 50 mL sterilized container and used as test sample. The composition of the conventional cleaners used in the farmhouses were: acidic cleaner [purified water (79.5), phosphoric acid (10), sulfuric acid (10), surfactant (0.5)] and alkaline cleaner [purified water (65), sodium hypochlorite (25), sodium hydroxide (10)]. The composition of the water-based cleaner of the present invention was: purified water (65), sodium carbonate (4), sodium phosphate (2), sodium hypochlorite (21), sodium polyacrylate (8).

2-2. Comparison of Total Bacterial Count

After using each cleaner, sample was taken from the final cleaning water in the pipeline and the raw milk tank. Total bacterial count was determined after diluting samples at 10 gradual concentrations and culturing in Mueller-Hinton agar (Difco, USA) for 24 hours.

As shown in the following Table 3, when the conventional cleaners were used, the total bacterial count at the milking line and the raw milk tank was 50 CFU (colony-forming unit)/mL and 2 CFU/mL, respectively. When the cleaner of the present invention was used, the total bacterial count was similar or lower. As a result, it was confirmed that the cleaner of the present invention is comparable to or better than the conventional cleaners.

TABLE 3

| | Total bacterial count in cleaning water (CFU/mL) | | | | |
|---|---|---|---|---|---|
| | | Present | Present | Present | Present |
| | | invention, | invention, | invention, | invention, |
| | Conven- | after | after | after | after |
| | tional | 1 day | 7 days | 15 days | 30 days |
| Milking line | 50 | 40 | 30 | 20 | 40 |
| Raw milk | 2 | 3 | 2 | 0 | 0 |
| tank | | | | | |

2-3. Comparison of Protein and Fat Removal Efficiency

Protein and fat removal efficiency was compared by measuring protein and fat contents in the cleaning water obtained in Test Example 2-1. Protein and fat contents were measured in the same manner as Test Examples 1-2 and 1-3, respectively.

As shown in the following Tables 4 and 5, the cleaner of the present invention and the conventional cleaners showed very similar protein and fat removal efficiency.

TABLE 4

| | | Conven- | Conven- | | |
|---|---|---|---|---|---|
| | | tional | tional | Conventional | |
| | Content/ | (farm- | (farm- | (farm- | Removal |
| | milk | house 1)/ | house 2)/ | house 3)/ | efficiency |
| | 100 mL | 100 mL | 100 mL | 100 mL | (average) |
| Protein (g) | 3.2 | 0.081 | 0.089 | 0.056 | 97.6% |
| Fat (g) | 3.9 | 0.087 | 0.091 | 0.079 | 97.8% |

TABLE 5

| | | Present | Present | Present | Present | Removal |
|---|---|---|---|---|---|---|
| | Content/ | invention, | invention, | invention, | invention, | efficiency |
| | milk 100 mL | after 1 day | after 7 days | after 15 days | after 30 days | (average) |
| Protein (g) | 3.3 | 0.091 | 0.076 | 0.072 | 0.062 | 97.8% |
| Fat (g) | 3.8 | 0.097 | 0.089 | 0.075 | 0.071 | 97.9% |

2-4. Comparison of Mineral Removal Efficiency

Mineral efficiency was compared by measuring Ca, K, P and Mg contents in the cleaning water obtained in Test Example 2-1. Mineral contents were measured in the same manner as Test Example 1-4.

As shown in the following Tables 6 and 7, the cleaner of the present invention and the conventional cleaners showed very similar mineral removal efficiency at both the milking line and the raw milk tank.

TABLE 6
Mineral contents in final cleaning water (100 mL) at milking line after use
of conventional cleaner or cleaner of the present invention

| | | | | | | | Removal |
|---|---|---|---|---|---|---|---|
| | | | Present | Present | Present | | efficiency, |
| | | | invention, | invention, | invention, | Removal | present |
| | Milk, | | after 7 | after 15 | after 30 | efficiency, | invention |
| | 100 mL | Conventional | days | days | days | conventional | (average) |
| Ca (mg/L) | 1,050 | 16.86 | 13.16 | 13.70 | 13.21 | 98.4% | 98.8% |
| P (mg/L) | 860 | 0.07 | 0.08 | 0.07 | 0.07 | 99.9% | 99.9% |
| K (mg/L) | 151 | 1.45 | 1.19 | 1.28 | 1.32 | 99.0% | 99.2% |
| Mg (mg/L) | 124 | 4.49 | 3.90 | 4.00 | 3.87 | 96.4% | 96.9% |

TABLE 7
Mineral contents in final cleaning water (100 mL) at raw milk tank after
use of conventional cleaner or cleaner of the present invention

| | | | | | | | Removal |
|---|---|---|---|---|---|---|---|
| | | | Present | Present | Present | | efficiency, |
| | | | invention, | invention, | invention, | Removal | present |
| | Milk, | | after 7 | after 15 | after 30 | efficiency, | invention |
| | 100 mL | Conventional | days | days | days | conventional | (average) |
| Ca (mg/L) | 1,050 | 16.56 | 13.56 | 13.04 | 13.08 | 98.5% | 98.8% |
| P (mg/L) | 860 | 0.27 | 0.06 | 0.07 | 0.07 | 99.9% | 99.9% |
| K (mg/L) | 151 | 1.37 | 1.20 | 1.11 | 1.18 | 99.0% | 99.3% |
| Mg (mg/L) | 124 | 4.37 | 3.87 | 3.92 | 3.90 | 96.4% | 96.9% |

As described above, the cleaner composition of the present invention provides the effect of removing fats, proteins, minerals, etc. comparable to or better than that of the conventional cleaner, and can reduce cleaning time and cost because the cleaning process is simplified. Hence, it can be utilized to clean milking machines or other appliances.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A cleaner composition comprising 5 to 15 weight % of an alkalic agent, 5 to 20 weight % of sodium polyacrylate having a molecular weight 4,000 to 10,000 as ion exchanger, 0.5 to 30 weight % of a sterilizer, and water as remainder

2. The composition as set forth in claim 1, wherein the alkalic agent is mixture of sodium carbonate and at least one compound selected from the group consisting of potassium carbonate, potassium bicarbonate, sodium phosphate, sodium metaphosphate, sodium pyrophosphate, potassium pyrophosphate, sodium silicate and sodium metasilicate

3. The composition as set forth in claim 1, wherein the sterilizer is at least one selected from the group consisting of sodium hypochlorite, sodium benzoate, sodium paraoxybenzoate, ethanol, chlorobutanol, hexamethylenetetramine, glutaraldehyde, chloroacetamide, quaternium-15, imidazolidinyl urea, potassium sorbate, p-hydroxybenzoic acid, benzyl ether of p-hydroxybenzoic acid, chloroxylenol, chlorothymol, 2,4-dichloro-3,5-xylenol, o-phenylphenol, 2-benzyl-4-chlorophenol, 2,4,4-trichloro-2-hydroxydiphenyl ether, 3,4,4-trichlorocarbanilide, 4,4-dimethyl-1,3-oxazolidine, polyhexamethylene biguanide hydrochloride, alkyltrimethylammonium bromide, benzalkonium chloride and benzethonium chloride.

4. A method for cleaning a milking machine using the cleaner composition as set forth in claim 1.

5. A method for cleaning a milking machine using the cleaner composition as set forth in claim 2.

6. A method for cleaning a milking machine using the cleaner composition as set forth in claim 3.

7. The cleaning method as set forth in claim 4, which comprises:
(a) washing (pre-cleaning) the milking machine with water;
(b) cleaning using the cleaner composition; and
(c) rinsing the cleaner remaining in the milking machine with water.

8. The cleaning method as set forth in claim 5, which comprises:
(a) washing (pre-cleaning) the milking machine with water;
(b) cleaning using the cleaner composition; and
(c) rinsing the cleaner remaining in the milking machine with water.

9. The cleaning method as set forth in claim 6, which comprises:
(a) washing (pre-cleaning) the milking machine with water;
(b) cleaning using the cleaner composition; and
(c) rinsing the cleaner remaining in the milking machine with water.
